(19) United States
(12) Patent Application Publication
(10) Pub. No.: US 2008/0155658 A1
(43) Pub. Date: Jun. 26, 2008

(54) Authentication type selection

(75) Inventors: Anu Leinonen, Tampere (FI); Kalle Tammi, Nokia (FI)

Correspondence Address: SQUIRE, SANDERS & DEMPSEY L.L.P., 8000 TOWERS CRESCENT DRIVE, 14TH FLOOR, VIENNA, VA, 22182-2700, US

(73) Assignee: Nokia Corporation

(21) Appl. No.: 11/643,684

(22) Filed: Dec. 22, 2006

(51) Int. Cl. G06F 21/00

(52) U.S. Cl. 726/4

(57) ABSTRACT

There is presented an authentication type selection for user authentication in a communication system supporting multiple authentication mechanisms. The authentication type selection may comprise a determination of an authentication scheme to be used for authenticating a user equipment based on information in a request from said user equipment, an indication about the authentication scheme to be used, and a determination of a type of an authentication scheme to be used for authenticating said user equipment based on a mapping between private and public user identities and usable authentication types.

### FIELD OF THE INVENTION

The present invention relates to authentication type selection. In particular, the present invention relates to a selection of an appropriate authentication type for user authentication in a communication system supporting multiple authentication mechanisms.

### BACKGROUND OF THE INVENTION

In view of an increasing number of communication technologies and technological concepts in use, there is a trend of convergence of networks and systems based on such different technologies and concepts into overall network systems. Examples for such different technologies may include GPRS (General Packet Radio Service) or CDMA (Code Divisional Multiple Access) or, in general, IP-based (IP: Internet Protocol) mobile or fixed networks. Further, there is a trend of convergence of different services, functions and applications into overall network systems. Such converged network systems are often referred to as next generation networks. Examples for such next generation networks include networks specified by 3GPP (Third Generation Partnership Project) or IETF (Internet Engineering Task Force) or TISPAN (Telecom and Internet Converged Services and Protocols for Advanced Networks).

For ensuring security and trustiness within such overall communication systems, which is particularly important for functions and services related to security-relevant, personal and/or confidential data, and for controlling access to such network systems and parts thereof, user authentication is executed. With respect to different technologies and networks, a plurality of authentication mechanisms have developed. In the following description, the term authentication mechanism is used as a generic term for particular authentication schemes and their subordinated types, e.g. options or alternatives.

As an example of a communication system, to which the present invention as described herein below may relate, there may be mentioned an IP Multimedia Subsystem (IMS). An IMS network may be considered as an IP-based delivery platform for provision of IP multimedia services including audio, video, text, chat, etc. In FIG. 1 of the accompanying drawings, a basic overview of an exemplary IMS architecture is illustrated, however only depicting those network elements which may be relevant for the subsequent description.

A terminal denoted by UE (for user equipment) is able to access the IMS network via an access network, two of which are shown as an example, and a proxy call session control function P-CSCF, i.e. a proxy control server. A proxy control server may interface with a single access network or with a plurality of access networks. All or some P-CSCFs of the IMS network are interconnected via an interrogating call session control function I-CSCF. Further, the P-CSCFs are connected with a serving call session control function S-CSCF, i.e. a session control server, which may exemplarily be connected with the I-CSCF. The S-CSCF and the I-CSCF both are connected with a home subscriber server HSS, which may (although this is not done herein) also be referred to as IP multimedia register IMR. In this regard, home subscriber server HSS may be understood as a combination of a user mobility server UMS and a home location register HLR, and IP multimedia register IMR may be understood as a combination of a user mobility server UMS and a subscription locator function SLF. The interface between a call session control function CSCF and a home subscriber server HSS and/or IP Multimedia Register IMR is usually referred to as Cx interface, as indicated in FIG. 1.

In an IMS network, the session initiation protocol (SIP) is usually employed as a session control protocol, and the Diameter protocol specified by the IETF is usually employed as an authentication, authorization and accounting (AAA) protocol. Hence, the HSS may act as a Diameter server and the CSCFs may act as SIP servers. In this regard, IMS defines a Diameter application to interact with the SIP during session setup, and defines other applications to perform and/or control other SIP services. There has been proposed a Diameter SIP application, which relates to an interworking of Diameter and SIP in that a SIP server relies on Diameter AAA infrastructure for authenticating a SIP request (for example, a SIP registration request such as a SIP REGISTER message) and authorizing the usage of particular SIP services.

For user authentication, there are several authentication schemes applicable in an IMS system, for example IMS AKA (AKA: authentication and key agreement) and Early-IMS-Security (EIS), which are the authentication schemes mainly related to herein. For the sake of completeness, NASS-bundled (NASS: network attachment subsystem) Authentication (NBA) and HTTP Digest could be mentioned as further conceivable authentication schemes.

FIG. 2 shows in a schematic manner a known authentication procedure according to 3GPP Early-IMS-security (EIS) authentication. The course of the procedure is indicated by the numbering of the steps illustrated. Otherwise, this figure should be self-explaining, so a detailed description thereof is not given herein.

According to a current specification of Early-IMS-security, for example, a registration request such as a SIP REGISTER message can be sent with or without an authorization header, which is normally required for defining information on authentication and authorization schemes to be employed. In the context of IMS AKA and EIS authentication schemes, if the S-CSCF receives such a SIP REGISTER message without an authorization header, it knows based on the missing authorization header that Early-IMS-Security (EIS) is the authentication scheme to be used. Accordingly, it sends a multimedia authentication request (MAR) command towards the HSS so that a predetermined information element in the MAR command, which regards the authentication scheme (e.g. attribute-value-pair “Authentication-Scheme” within grouped attribute-value-pair “SIP-Auth-Data-Item”), contains Early-IMS-Security as the authentication scheme to be used for authenticating the requesting user (equipment).

Based on current specifications in 3GPP there are, however, cases when the session control server S-CSCF cannot determine which authentication scheme is to be utilized. That makes the decision on which authentication scheme to be applied for a particular registration difficult or in certain cases even impossible.

As an example scenario in this regard, it is to be noted that network operators, although operating advanced networks, may have customers in their network, who still have old-fashioned terminals, for example second generation (2G) terminals, and/or terminals having a subscriber identity module (SIM). For example, terminals having a subscriber identity module (SIM) support Early-IMS-Security (EIS) authentication, but do not support IMS AKA authentication. Furthermore, for up-to-date terminals having a universal subscriber identity module (USIM), there are options in that EIS or IMS AKA using USIM may be executed with or without an IP security protocol (IPSec). In case of a user having a USIM, the user may switch the USIM between EIS capable terminal or IMS AKA capable terminal.

Although a missing authorization header in a registration message (e.g. SIP REGISTER) is an indication of the use of EIS authentication, as mentioned above, some of existing terminals are configured to send an authorization header anyway, i.e. even in EIS authentication. Hence, such terminals do not operate according to current standards. If such a terminal sends an authorization header in EIS authentication, it is currently difficult or even impossible for the network (i.e. S-CSCF or HSS, for example) to distinguish between EIS and IMS AKA without IPSec authentication, because e.g. the SIP REGISTER messages looks exactly the same for both authentication schemes. In addition to or alternatively to the above-mentioned non-compliance with current standards, some terminals might violate current standards in that they do not send a security-client header, i.e. an integrity protection specification, in IMS AKA authentication. This may raise similar problems as described above.

Moreover, even when a control server, e.g. S-CSCF, is able to make a decision on a certain authentication scheme to be used, e.g. either AKA scheme or EIS scheme, it could nonetheless be difficult or even impossible for a register node, e.g. HSS, to make a decision on a particular authentication type of said authentication scheme. For example, when AKA is decided as authentication scheme, either USIM AKA or ISIM AKA could be an appropriate authentication type, whereas when EIS is decided as authentication scheme, either EIS or HTTP Digest could be an appropriate authentication type.

Especially in convergence networks supporting multiple authentication mechanisms, such an irresolvable ambiguity poses an essential problem for user authentication.

Further, in view of different options and alternatives in user authentication, there exists a problem in that operators need to coordinate between IP Multimedia Register (IMR) provisioning, SIM/USIM capability and terminal capability. Therefore, there exists a further problem in that it is not possible to provision only one and the same authentication type to all subscribers such that a terminal can decide which authentication mechanism is performed, e.g. either EIS or IMS AKA with USIM.

This is based on the fact that newer terminals will most likely attempt to authenticate by means of IMS AKA first. An IMS AKA authentication could be executed with USIM, hereinafter referred to as USIM AKA, if they have USIM inside, or could be executed with ISIM (IP multimedia services identity module), hereinafter referred to ass ISIM AKA, when they have ISIM inside. Otherwise, older terminals will presumably still use EIS authentication. In addition, some users may have such terminals which are capable of executing IMS AKA authentication, but without IPSec. Then, it will be needed that the operators may perform EIS or IMS AKA with USIM, but without IPSec. There has not been presented any solution in this regard.

Thus, a solution to the above problems is needed for providing a suitable authentication type selection in a communication system supporting multiple authentication mechanisms.

### SUMMARY OF THE INVENTION

Hence, it is an object of the present invention for example that it may remove at least some of the above problems and may provide a solution for authentication type selection in a communication system supporting multiple authentication mechanisms.

According to an aspect of the invention, the above object is for example achieved by a method comprising determining, at a control server apparatus, an authentication scheme to be used for authenticating a user equipment based on information in a request from said user equipment, indicating, from said control server apparatus to a register apparatus, the authentication scheme to be used, and determining, at said register apparatus, a type of an authentication scheme to be used for authenticating said user equipment based on a mapping between private and public user identities and usable authentication types.

According to an aspect of the invention, the above object is for example achieved by a method for operating a control server apparatus, comprising determining an authentication scheme to be used for authenticating a user equipment based on information in a request from said user equipment, and indicating, to a register apparatus, the authentication scheme to be used.

According to an aspect of the invention, the above object is for example achieved by a method for operating a register apparatus, comprising receiving an indication from a control server apparatus about an authentication scheme to be used for authenticating a user equipment, and determining a type of an authentication scheme to be used for authenticating said user equipment based on a mapping between private and public user identities and usable authentication types.

According to an aspect of the invention, the above object is for example achieved by a control server apparatus, for example an S-CSCF, comprising a determination unit configured to determine an authentication scheme to be used for authenticating a user equipment based on information in a request received from said user equipment, and an indication unit configured to indicate, to a register apparatus, the authentication scheme to be used.

According to an aspect of the invention, the above object is for example achieved by a register apparatus, for example an HSS and/or IMR, comprising a receiver configured to receive an indication from a control server apparatus about an authentication scheme to be used for authenticating a user equipment, and a determination unit configured to determine a type of an authentication scheme to be used for authenticating said user equipment based on a mapping between private and public user identities and usable authentication types.

According to an aspect of the invention, the above object is for example achieved by a system comprising a control server apparatus according to an aspect of the present invention and a register apparatus according to an aspect of the present invention.

According to further aspects of the present invention, the above object may for example be accomplished by a computer program, circuit arrangement or the like for carrying out a method according to an aspect of the present invention and/or for operating an apparatus (or network element) according to an aspect of the present invention to carry out the respective method/s.

According to a further aspect of the present invention, there is provided a data structure, wherein an authentication scheme information element in a multimedia authentication request, MAR, command is set to be undefined.

Further developments and/or modifications are set out in the appended claims.

Embodiments of the present invention provide for a solution to an ambiguity problem of current standards, in particular but not exclusively in combination with terminals not supporting current standards.

By virtue of embodiments of the present invention, authentication mechanisms of “old” user equipments with a subscriber identity module (SIM) card, e.g. 2G terminals or terminals supporting EIS, but not supporting IMS AKA, may be operated in “new” systems such as 3G systems, e.g. in an IMS network. Stated in other words, it is enabled by embodiments of the present invention that such “old” user equipments, which are not compliant to current standards, may be handled by network elements according to current standards, e.g. S-CSCF and HSS.

Stated in other words, according to embodiments of the present invention, a user or subscriber may be provided with only one authentication type, and the network (e.g. IMS) may be able to authenticate the user or subscriber according to the authentication scheme which the user equipment has started, even when the user equipment sends an authorization header in EIS authorization or starts authentication and key agreement without IPSec.

As an example, a user with a terminal having a USIM and being capable of EIS and a user with a terminal having a USIM and being capable of AKA may have the same authentication type provisioned, which is herein exemplarily referred to as authentication type “USIM AKA or EIS”. According to embodiments of the present invention, it is feasible that a register such as HSS may eventually send different authentication mechanisms to a control server such as S-CSCF, even though users/user equipments have the same authentication type provisioned. In the example, although the users have the same authentication type “USIM AKA or EIS” provisioned, the finally assigned authentication mechanism may be different (e.g. USIM AKA or EIS) based on an authentication scheme indicated by the control server, e.g. S-CSCF. Such a different result of authentication scheme determination may for example be based on different terminal capabilities.

By virtue of embodiments of the present invention, it may be possible (for operators) to start using IMS AKA with USIM authentication without a need to coordinate between IP Multimedia Register (IMR) provisioning, SIM/USIM capability and terminal capability.

According to embodiment of the present invention, a specifically designed authentication type “USIM AKA or EIS” is defined and specified in a HSS database, in particular a UMS database. This authentication type may be used both in cases where an authentication scheme is undefined and in cases where an authentication scheme is defined, but an authentication type is to be determined. This is also advantageous for the operator, because the operator does not need to configure the exact authentication type at an HSS database for each user, because the used authentication type by the user/user equipment might change when the user changes for example the phone (for example between “USIM AKA” and “EIS”).

### BRIEF DESCRIPTION OF THE DRAWINGS

In the following, the present invention will be described in greater detail with reference to the accompanying drawings, in which

FIG. 1 shows a basic overview of an IMS architecture,

FIG. 2 shows in a schematic manner a known authentication procedure according to Early-IMS-security authentication,

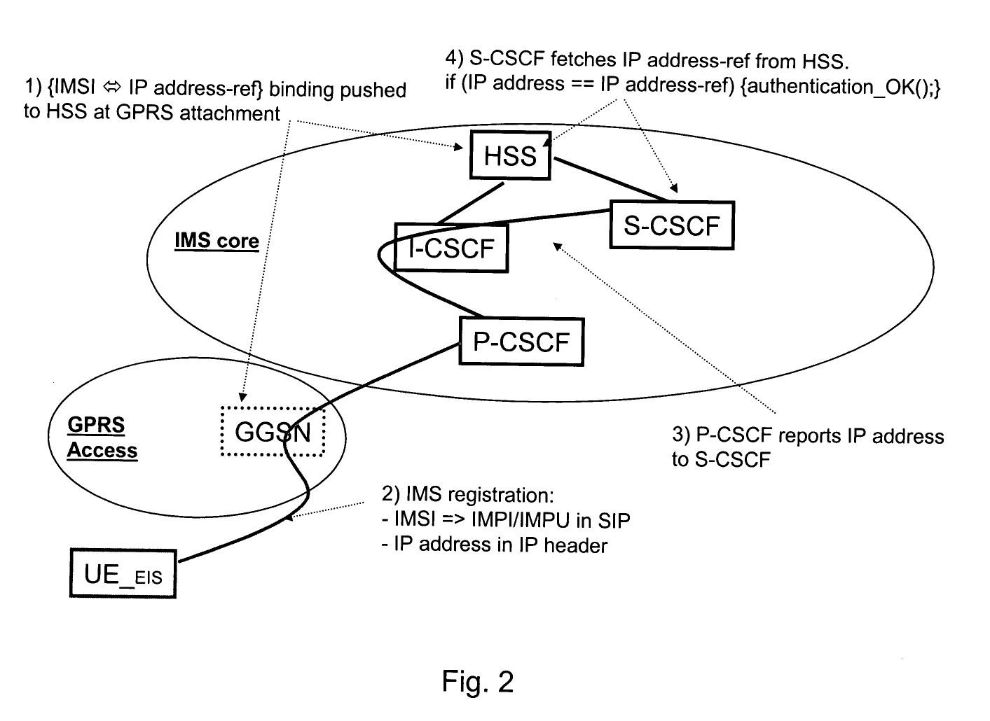

FIG. 3 shows a signaling diagram of a method according to an embodiment of the present invention,

FIG. 4 shows a flow chart of a method according to an embodiment of the present invention,

FIG. 5 shows a flow chart of a method according to an embodiment of the present invention,

FIG. 6 shows a schematic block diagram of apparatuses according to embodiments of the present invention, and

FIG. 7 shows an overview of an overall system processing according to an embodiment of the present invention.

### DETAILED DESCRIPTION OF EMBODIMENTS OF THE PRESENT INVENTION

The present invention is described herein with reference to particular non-limiting examples. A person skilled in the art will appreciate that the invention is not limited to these examples and may be more broadly applied.

In particular, the present invention is described in relation to a Diameter SIP application which is used for offering authentication and authorization services of a Diameter server for SIP servers. In this regard, SIP is used as a particular example of a session control protocol and Diameter is used as a particular example of an AAA protocol. In the particular 3GPP architecture, the present invention is applicable to the IP Multimedia Subsystem (IMS) as well as to a Push-to-talk-over-Cellular (PoC) service, for example. In particular, in accordance with the described example scenarios, the present invention mainly relates to the Cx interface between a home subscriber server HSS acting as an AAA (Diamater) server and a call session control function CSCF acting as a session control (SIP) server. As example authentication schemes, EIS and IMS AKA authentication are mainly used. Such terminology is however only used in the context of the presented examples and does not limit the invention in any way.

Rather, the present invention and embodiments thereof are as well applicable to other network frameworks and other authentication schemes as long as similar problems as described above exist.

Basically, embodiments of the present invention relate to a selection of an appropriate authentication type, i.e. a type of an authentication scheme, for user authentication in a communication system supporting multiple authentication mechanisms. According to a general embodiment, such a method comprises a determination of an authentication scheme at a control server node such as a S-CSCF and a determination of an authentication type at a register node such as a HSS and/or IMR.

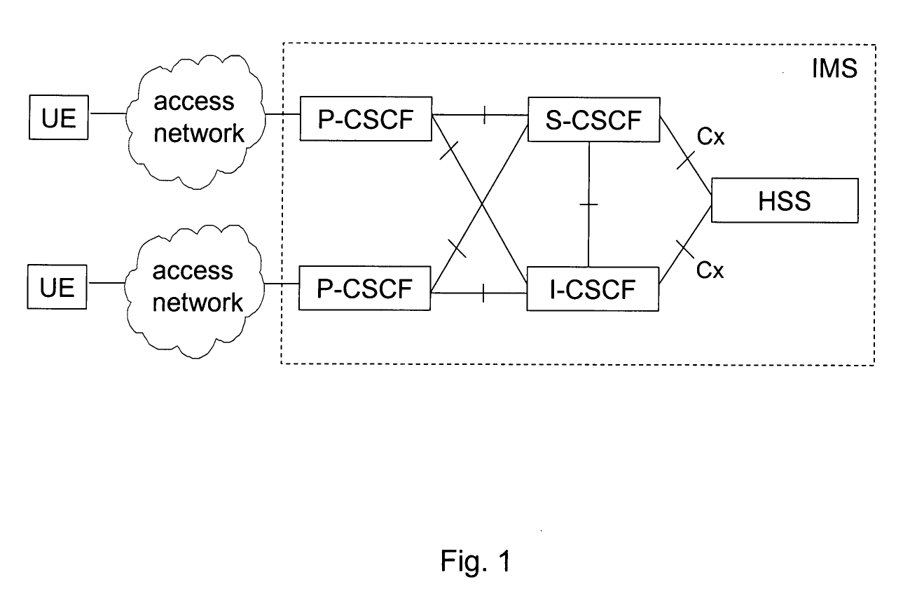

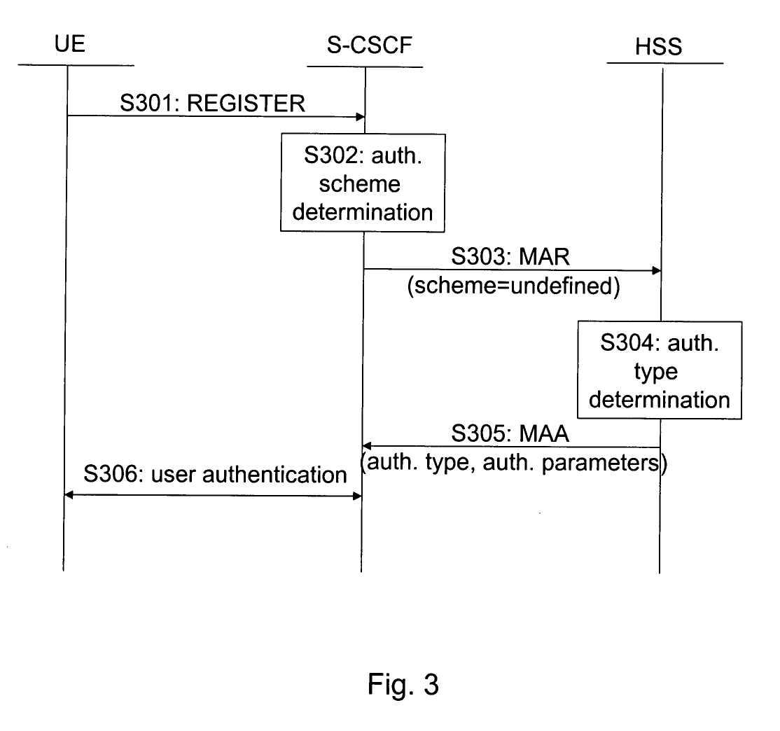

FIG. 3 shows a signaling diagram of a method according to an embodiment of the present invention. In FIG. 3, the present embodiment is exemplarily illustrated by means of a user equipment UE exemplarily representing a user or terminal to be authenticated, a serving call state control function S-CSCF exemplarily representing a control server node/apparatus, and a home subscriber server HSS or IP multimedia register IMR, respectively, exemplarily representing a register node/apparatus. The three communication entities UE, S-CSCF and HSS may for example be arranged according to an architecture as shown in FIG. 1. That is, these three communication entities may represent an underlying IMS or PoC system, or may be involved in a Diameter SIP application.

According to the embodiment of FIG. 3, a user equipment UE sends a registration request to a control server such as a S-CSCF (step S301). The registration request is exemplarily illustrated as a SIP REGISTER message. In view of example scenarios described above, the user equipment UE may for example be a terminal which includes an authorization header in the registration request, although this should not be done, when requesting EIS authentication. Alternatively, the user equipment UE may for example be a terminal which starts AKA authentication without IPSec and, although this should be done, does not set an integrity protection parameter in the request message.

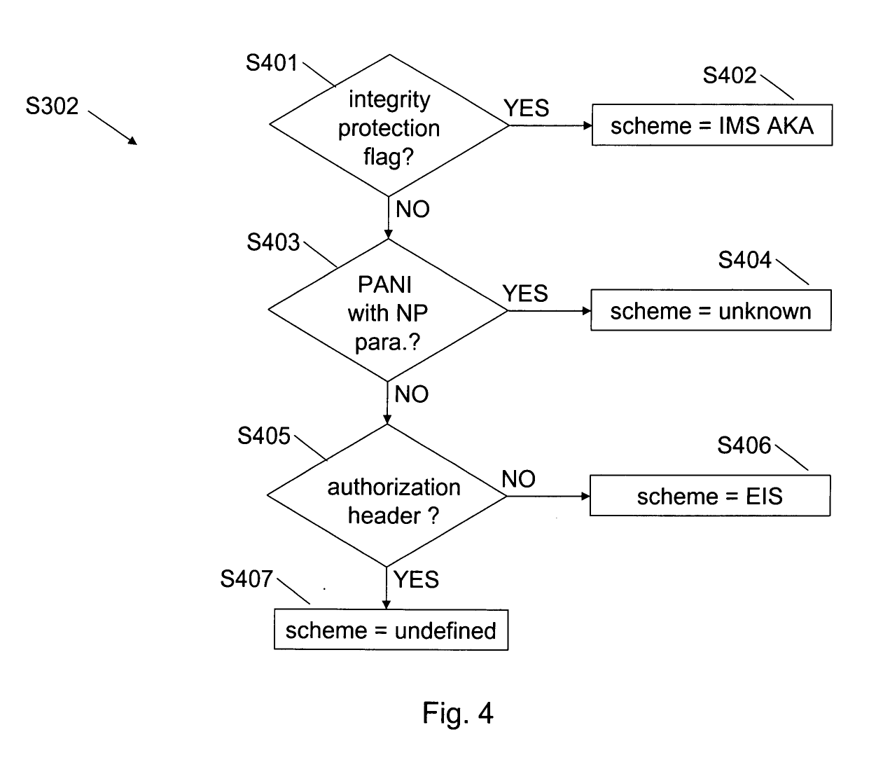

Upon receipt of the registration request, i.e. for example the REGISTER message, from the user equipment UE to be authenticated, the control server S-CSCF in step S302 performs an authentication scheme determination. Details thereof are described in connection with FIG. 4 below. According to the result of the authentication scheme determination of step S302, the control server indicates the respectively determined authentication scheme to a register node HSS. For example, Digest-AKAv1-MD5 or Early-IMS-Security may be indicated as determined authentication scheme. However, it could also be indicated that the authentication scheme to be used is unknown. According to the present embodiment, the control server S-CSCF may, in case the determination of step S302 does not yield a definite result, also indicate to the HSS that the authentication scheme is undefined.

In case of a determination of an undefined authentication scheme in step S302, the S-CSCF may according to the present embodiment send a multimedia authentication request (MAR) command as an example of an authentication request to the register node HSS (step S303). In this MAR command, an authentication scheme information element may according to the present embodiment be set to be undefined.

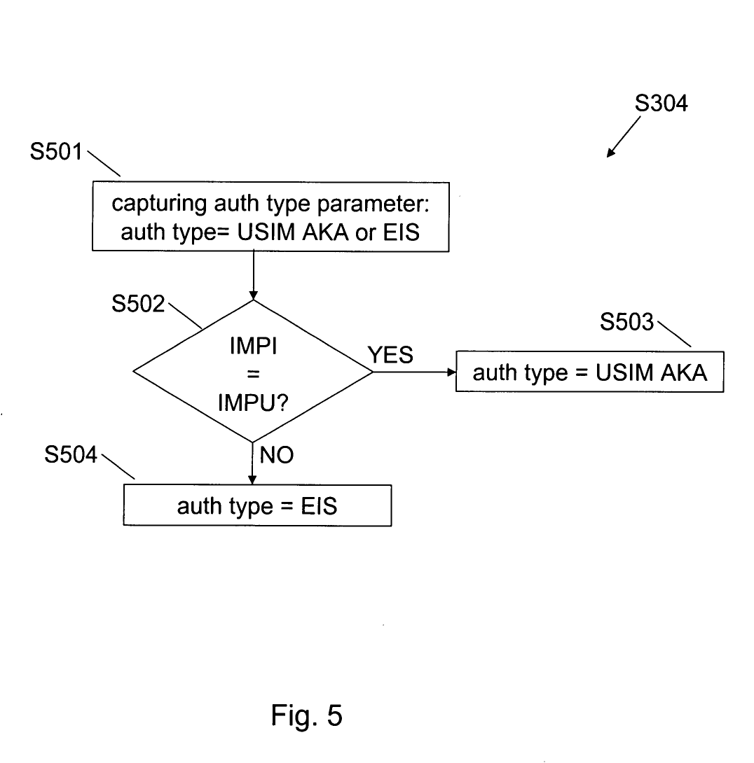

Upon receipt of the authentication request, i.e. for example the MAR command, with undefined scheme indication from the S-CSCF, the HSS in step S304 performs an authentication type determination, i.e. a determination of a type of authentication scheme to be used for authenticating the requesting user equipment UE. Details thereof are described in connection with FIG. 5 below. That is, based on the received scheme, e.g. undefined, and an authentication type being stored for the user equipment UE and possibly some additional logic, the HSS determines which authentication type is to be used. According to the result of the authentication type determination of step S304, the register node indicates the respectively determined authentication type to the control server S-CSCF. Such an indication of an authentication type may for example be effected by means of a multimedia authentication answer (MAA) command as an example of an authentication response, which is sent from the HSS to the S-CSCF (step S305). In the response of step S305, in addition to the determined authentication type (e.g. USIM AKA or EIS), corresponding authentication parameters required for the determined authentication mechanism may be provided. Such parameters may be retrieved by the register node for example from an internal storage unit (database).

Upon receipt of the MAA command, the control server S-CSCF may, according to the illustrated embodiment of FIG. 3, initiate a user authentication with the requesting user equipment (step S306). To this end, the determined authentication type/mechanism and the provided authentication parameters may be utilized accordingly.

FIG. 4 shows a flow chart of a method according to an embodiment of the present invention, which may exemplarily be executed as the method of step S302 according to the embodiment shown in FIG. 3.

When a registration request is received at a control server, the method according to FIG. 4 is for example executed for determining an authentication scheme to be used for user authentication.

In step S401, a first detection is made for detecting whether or not the request specifies integrity protection. According to the illustrated embodiment, the first detection of step S401 is performed by checking the existence of an integrity-protected flag in the received request. As defined in current standards, such an integrity-protected flag exists, if at all, in an authorization header in a SIP REGISTER message. If such an integrity-protected flag is present in the request, i.e. if integrity protection is specified (YES in step S401), it is known by the control server that IMS AKA is to be used as authentication scheme, thus effecting a respective determination in step S402. If such an integrity-protected flag is not present in the request, i.e. if integrity protection is not specified (NO in step S401), according to current standards, it would be known by the control server that the authentication scheme is not IMS AKA. However, as explained above, this assumption does not necessarily have to be true. Therefore, in order to solve this problematic issue, according to the present embodiment, it is known here by the control server that the authentication scheme is not IMS AKA with IPSec. In this case, the flow proceeds to step S403.

In step S403, a second detection is made for detecting whether or not network-provided access network information exists in the received request. According to the illustrated embodiment, the second detection of step S403 is performed by checking the existence of a PANI (P-Access-Network-Info) header with an NP (network-provided) parameter. As defined in current standards, such a PANI header with NP parameter is a SIP extension header and is used in NASS-bundled authentication (NBA), which is an authentication scheme defined for TISPAN. The NP parameter for designating network-provision is added by a proxy server such as a P-CSCF. If such a header and parameter is present in the request, i.e. if network-provided access network information exists in the request (YES in step S403), the authentication scheme is determined to be unknown in step S404. If such a header and parameter is not present in the request, i.e. if network-provided access network information does not exist in the request (NO in step S403), the authentication scheme can not be NBA, and the flow proceeds to step S405.

In step S405, a third detection is made for detecting whether or not the request contains an authorization header. If no authorization header exists in the request (NO in step S405), it is known by the control server that EIS is to be used as authentication scheme, thus effecting a respective determination in step S406. If an authorization header exists in the request (YES in step S405), the above-described problem of ambiguity arises in that no authentication scheme can be definitely determined. According to the present embodiment, the authentication scheme is set to be undefined in step S407.

As a result, if no integrity-protected flag exists (i.e. first detection yields a negative result), no PANI header with NP parameter exists (i.e. second detection yields a negative result), and an authorization header exists (i.e. third detection yields an affirmative result), according to an embodiment of the present invention, it is determined by the control server S-CSCF that an undefined scheme is to be used.

Accordingly, in response to the undefined determination of step S302/S407, the control server will indicate to the register node that no definite authentication scheme to be used is determined (cf. step S303 of FIG. 3).

Although the sequence of the first to third detections according to FIG. 4 is shown as an example, it could also be thought of different kinds of detection achieving the desired result. In this case, the sequence of such detections may also be modified.

FIG. 5 shows a flow chart of a method according to an embodiment of the present invention, which may exemplarily be executed as the method of step S304 according to the embodiment shown in FIG. 3.

When an authentication request (e.g. MAR command with undefined authentication scheme) is received at a register node, the method according to FIG. 5 is for example executed for determining an authentication type to be used for user authentication.

Upon receipt of an indication of an undefined authentication scheme from a control server S-CSCF, at least within the framework of present embodiments, the register node knows that the authentication type can either be USIM AKA or EIS. This knowledge is based on current standards in connection with the preceding scheme determination and the detections made at the S-CSCSF. Accordingly, in step S501, a choice of authentication and key agreement, AKA, authentication using a universal subscriber identity module, USIM (herein referred to as USIM AKA), and Early IMS Security (herein referred to as EIS) is captured as an authentication type parameter. This is based on an implementation of “USIM AKA or EIS” as an authentication type and a related logic at the HSS.

Namely, besides authentication types such as e.g. USIM AKA, ISIM AKA, EIS, etc., another authentication type “USIM AKA or EIS” is implemented at the HSS according to embodiments of the present invention.

In step S502, the register node HSS performs a comparison between a private user identity of the user equipment UE, which according to IMS specifications may for example be an IP multimedia private identity (IMPI), and a public user identity of the user equipment UE, which according to IMS specifications may for example be an IP multimedia public identity (IMPU). The private and public user identities may be forwarded in the authentication request from the S-CSCF to the HSS, or may be pre-stored. In this regard, it is noted that both IMPI and IMPU usually consist of a uniform resource identifier (URI). The IMPI is unique to the user equipment UE, and one may have multiple IMPUs per IMPI. The IMPU can also be shared with another user equipment, so both can be reached with the same identity. The HSS user database contains, but is not limited to, the IMPU, IMPI, and the like.

If it is found in step S502 that IMPI and IMPU match each other, i.e. that they are equal except for the expression “sip:” and the port number and URI parameters, which the IMPI does not contain, USIM AKA is determined as the authentication type to be used (step S503). This determination is based on the fact that, in IMS AKA with USIM authentication, both IMPI and IMPU are derived from a IMSI(international mobile subscriber identity) of the user equipment UE, which is stored in the USIM thereof.

If it is found in step S502 that IMPI and IMPU do not match each other, EIS is determined as the authentication type to be used (step S504). This is based on the fact that, if the UE sends an authorization header in EIS authentication, it does not use IMSI derived IMPU as it does not support implicit registration either.

Basically, the determination of the authentication type may be considered to be based on the specifically designed authentication type “USIM AKA or EIS”, as described above, and further that only one type, i.e. USIM AKA or EIS, is stored in the HSS database to be used for one user equipment, i.e. one IMPI. Stated in other words, the authentication type determination is based on a mapping between private and public user identities and usable authentication types.

From an implementation point of view, the above-described operation of the HSS may be detailed as follows.

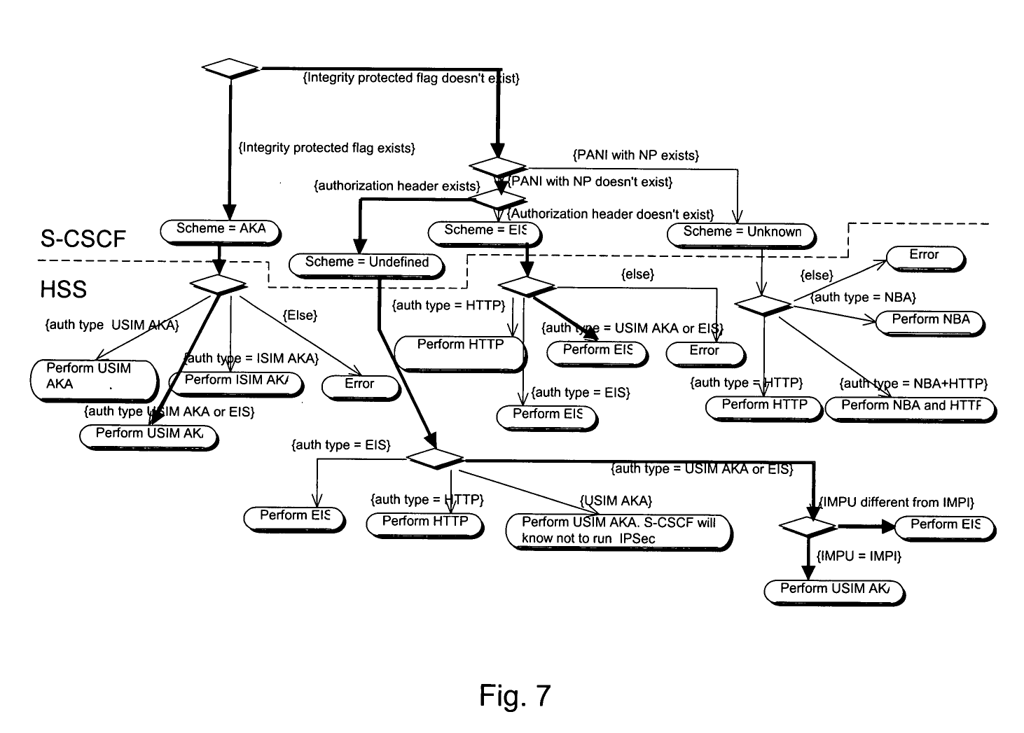

The HSS can be split into a home location register (HLR) part and a user mobility server (UMS) part. Both the HLR and the UMS may include separate databases (which are not explicitly shown herein) where user specific data is stored. In particular, data needed for IMS authentication is mostly stored in the database of the UMS part, whereas some data needed for USIM AKA authentication (e.g. an authentication key) may be stored in the database of the HLR part. In the UMS database there is only one authentication type stored for each IMPI, which can be for example “USIM AKA” or “EIS”, for the framework of present embodiments. According to present embodiments, there is introduced a new authentication type value which can be stored in the database. This is named “USIM AKA or EIS”. If the S-CSCF indicates an undefined authentication scheme to the HSS, the authentication type stored in the UMS database is checked for the accompanying IMPI. On the basis of the read authentication type it is continued like shown in FIG. 5 or 7. For example, if the read authentication type from the UMS database for the IMPI is “USIM AKA or EIS”, it is further branched to the check if the IMPI equals the IMPU. Further, on the basis of this check, authentication type IMS AKA, in particular USIM AKA, is identified or authentication type EIS is identified.

The above description of embodiments of the present invention is, merely by way of example, focused on cases where the authentication scheme to be used is determined to be undefined at a control server, e.g. S-CSCF. However, it will be readily understood that embodiments of the present invention also relate to and cover other cases of ambiguities relating to authentication type selection.

For example, when the authentication scheme is determined to be IMS AKA (cf. step S402 of FIG. 4), there may still exist an ambiguity about the authentication type to be used. Accordingly, such a determination of the appropriate authentication type at the HSS may as well be performed according to present principles. In detail, by means of the authentication type parameter “USIM AKA or EIS” according to embodiments of the present invention, the HSS is able to determine USIM AKA to be the authentication type to be used, and not ISIM AKA (cf. FIG. 7 below). Similarly, when the authentication scheme is determined to be EIS (cf. step S406 of FIG. 4), there may still exist an ambiguity about the authentication type to be used. Accordingly, such a determination of the appropriate authentication type at the HSS may as well be performed according to present principles. This means that the same or a similar scheme determination (e.g. detections), the same or a similar type determination (e.g. capturing), and the same or similar indications (e.g. MAR and MAA commands with respectively set information elements) may be utilized. In detail, by means of the authentication type parameter “USIM AKA or EIS” according to embodiments of the present invention, the HSS is able to determine EIS to be the authentication type to be used, and not HTTP Digest (cf. FIG. 7 below).

The same or a similar database checking operation as described above in connection with FIG. 5 may be performed in these cases.

Of course, these notions apply as well for devices, modules, systems, computer programs and circuit arrangements as described in the following. That is, although not described explicitly, the structural embodiments of the present invention are as well configured for the cases according to any one of steps S402, S406 and S407 of FIG. 4. Although embodiments of the present invention are described above mainly with respect to methods and operations performed, the present invention as a matter of course also covers respectively adapted and configured devices, modules, systems, computer programs and circuit arrangements for implementation of the described methods and operations in hardware and/or software.

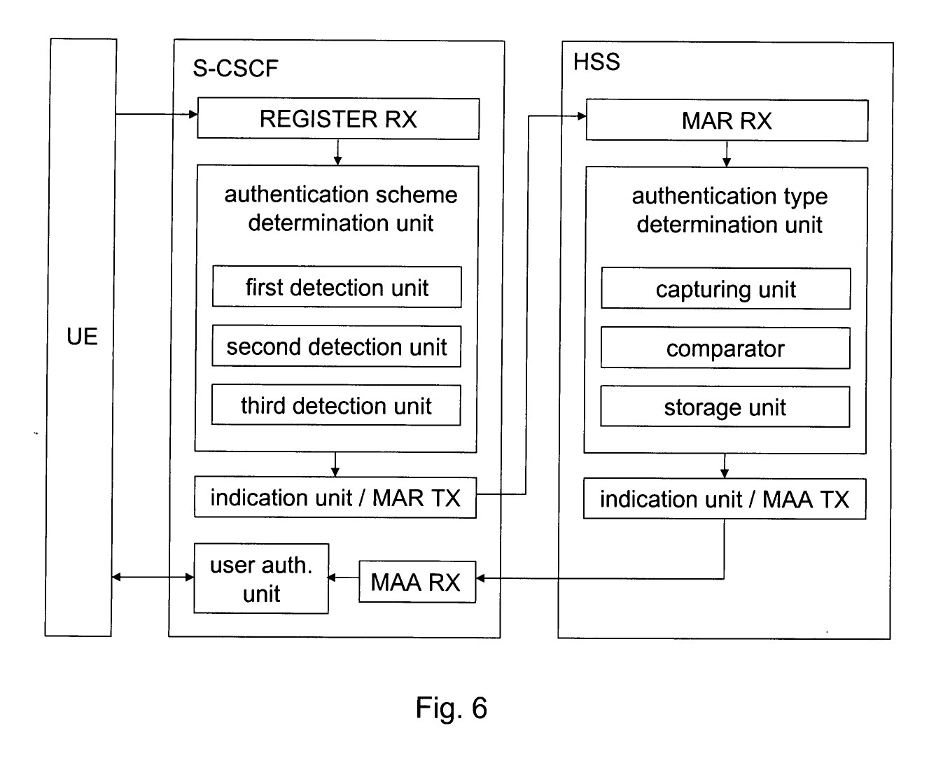

FIG. 6 shows a schematic block diagram of apparatuses according to embodiments of the present invention, which are adapted for the methods according to FIGS. 3 to 5, respectively. Namely, FIG. 6 schematically illustrates a control server apparatus or node, denoted by S-CSCF, according to an embodiment of the present invention, and a register apparatus or node, denoted by HSS, according to an embodiment of the present invention. It may also be understood that FIG. 6 schematically illustrates a system according to an embodiment of the present invention, wherein such a system may comprise a combination of S-CSCF and HSS as well as a combination of S-CSCF, HSS and a user equipment UE.

It is further to be noted that FIG. 6 shows an example embodiment, and apparatuses or a system according to the present invention do not have to contain all of the functional blocks shown in FIG. 6. The arrows between the functional blocks and entities are intended to illustrate the signal flow. A plurality of connecting arrows between UE and S-CSCF or S-CSCF and HSS do not necessarily mean that several physical connections exist.

According to the embodiment of FIG. 6, a control server S-CSCF comprises an authentication scheme determination unit including special logic of the S-CSCF according to embodiments of the present invention. In particular, this unit is for implementing an operation according to the method shown in FIG. 4. Furthermore, the present S-CSCF comprises a receiver which is for receiving registration requests from the user equipment UE, thus being denoted by REGISTER RX. The REGISTER RX unit forwards the received request from the UE to the authentication scheme determination unit, where the request is processed, and from which the determination result, i.e. for example undefined scheme, is output to an indication unit. According to the illustrated embodiment, the indication unit is for indicating from the S-CSCF to the HSS that the authentication scheme to be used is undefined. In view of an example implementation of such an indication in an MAR command, as described above, the indication unit may also comprise a transmitter (MAR TX) for transmitting a corresponding MAR command to the HSS. Moreover, the control server of the present embodiment comprises a receiver, exemplarily denoted by MAA RX in FIG. 6, which is for receiving an indication of a determined authentication type from the HSS, which is exemplarily implemented by means of a corresponding MAA command. The received MAA command, i.e. the received authentication response, may be forwarded by the MAA receiver to a user authentication unit, which utilizes the indicated information, i.e. determined authentication type (e.g. USIM AKA or EIS) and appropriate authentication parameters for that type, for authenticating the requesting user equipment UE.

According to the present embodiment, the first to third detection units of the authentication scheme determination unit are configured for performing the first to third detections in steps S401 to S407 according to FIG. 4. For details, reference is made to the description of FIG. 4.

According to the embodiment of FIG. 6, a register HSS comprises an authentication type determination unit including special logic of the HSS according to embodiments of the present invention. In particular, this unit is for implementing an operation according to the method shown in FIG. 5. Furthermore, the present HSS comprises a receiver which is for receiving an indication of a determined authentication scheme (i.e. for example undefined scheme) from the control server S-CSCF, e.g. for receiving a corresponding MAR command, thus being exemplarily denoted by MAR RX. The MAR RX forwards the received indication or authentication request (e.g. MAR command) from the S-CSCF to the authentication type determination unit, where the request is processed, and from which the determination result, i.e. for example USIM AKA or EIS, is output to an indication unit. According to the illustrated embodiment, the indication unit is for indicating from the HSS to the S-CSCF the determined authentication type to be used for user authentication. In view of an example implementation of such an indication in an MAA command, as described above, the indication unit may also comprise a transmitter (MAA TX) for transmitting a corresponding MAA command including determined authentication type and appropriate parameters to the control server S-CSCF.

According to the present embodiment, the capturing unit and the comparator of the authentication type determination unit are configured for performing the operations in steps S501 to S504 according to FIG. 5. For details, reference is made to the description of FIG. 5. In the storage unit (database), there may be stored private and public user identities (e.g. IMPI, IMPU), a mapping between private user identities and authentication types being usable, and authentication parameters for different authentication types.

For general reference, FIG. 7 shows an overview of an overall system processing according to an embodiment of the present invention. According to FIG. 7, the procedures of the upper part above the broken line are performed at a control server, e.g. S-CSCF, and the procedures of the lower part below the broken line are performed at a register node, e.g. HSS and/or IMR.

The illustration of FIG. 7 is intended to serve for an overall comprehension of the present invention, its embodiments and its surrounding. Furthermore, the illustration of FIG. 7 is intended to provide for arranging the present invention, its embodiments and its surrounding into an overall logical coherence. In particular, those branches and details not explained in connection with FIGS. 3 to 5 are schematically illustrated.

As the illustration of FIG. 7 is deemed to be self-explaining for a skilled person, in particular with respect to the above explanations, a detailed description thereof is not regarded to be essential for the understanding of the present invention. Exemplary method flows according to embodiments of the present invention are indicated in FIG. 7 by means of broader lines.

As can be gathered from FIG. 7, a finally determined authentication type may be USIM AKA, if the S-CSCF indicates AKA as authentication scheme, and a finally determined authentication type may be EIS, if the S-CSCF indicates EIS as authentication scheme, and a finally determined authentication type may be either USIM AKA or EIS, if the S-CSCF indicates the authentication scheme to be undefined.

Any methods and operations as well as any structural features described above may of course be implemented by way of software and/or hardware.

It is to be noted that the term “undefined” as used throughout the description and claims is intended to represent a general expression for the fact that no authentication scheme may be definitely determined. Hence, the term “undefined” is to be understood as an example name for such a case. As a matter of course, any other term may also be used for such a case, when implementing the principles according to embodiments of the present invention. In particular, as regards messages for indicating such an undefined case, any conceivable denomination may be used for any parameter or information element in such a message, as long as this denomination is defined to represent the described case. For example, a respective parameter or information element may be denoted by “NO_INTEGRITY_PROTECTED”.

In general, it is to be noted that respective functional elements according to above-described aspects can be implemented by any known means, either in hardware and/or software, respectively, if it is only adapted to perform the described functions of the respective parts. The mentioned method steps can be realized in individual functional blocks or by individual devices, or one or more of the method steps can be realized in a single functional block or by a single device.

Furthermore, method steps and functions likely to be implemented as software code portions and being run using a processor at one of the entities are software code independent and can be specified using any known or future developed programming language such as e.g. Java, C++, C, and Assembler. Method steps and/or devices or means likely to be implemented as hardware components at one of the entities are hardware independent and can be implemented using any known or future developed hardware technology or any hybrids of these, such as MOS, CMOS, BiCMOS, ECL, TTL, etc, using for example ASIC components or DSP components, as an example. Generally, any method step is suitable to be implemented as software or by hardware without changing the idea of the present invention. Devices and means can be implemented as individual devices, but this does not exclude that they are implemented in a distributed fashion throughout the system, as long as the functionality of the device is preserved. Such and similar principles are to be considered as known to those skilled in the art.

Generally, for the purpose of the present invention as described herein above, it should be noted that
a communication device or terminal may for example be any device by means of which a user may access a network and/or a server of such network; this implies mobile as well as non-mobile devices and networks, independent of the technology platform on which they are based; only as an example, it is noted that terminals operated according to principles standardized by the 3^{rd} Generation Partnership Project 3GPP and known for example as UMTS terminals (Universal Mobile Telecommunication System) are particularly suitable for being used in connection with the present invention, nevertheless terminals conforming to standards such as GSM (Global System for Mobile communications) or IS-95 (Interim Standard 95) may also be suitable;
networks referred to in this connection may comprise mobile and fixed network sections independent of the type of technology on which the networks are operated, for example those networks operate on the basis of the Internet Protocol IP, independent of the protocol version (IPv4 or IPv6), or on the basis of any other packet protocol such as User Datagram Protocol UDP, etc.
devices can be implemented as individual devices, devices may also be implemented as a module configured to accomplish interoperability with other modules constituting an entire apparatus, e.g. a module device may be represented as a chipset or chip card e.g. insertable and/or connectable to an apparatus such as a mobile phone, or a module may be realized by executable code stored to a mobile phone or other device for execution upon invocation.

In terms of the above examples, there is presented an authentication type selection method performed by S-CSCF and HSS for mobile user equipment using EIS-based authentication with security headers or using AKA authentication without IPSec. Based on an authentication scheme determination by the S-CSCF, the HSS decides between IMS/USIM AKA without IPSec and EIS authentication. Thereby, for example, when an authorization header exists in a registration request from the user equipment, and an integrity protected flag does not exist within the authorization header, an authentication scheme is set to be undefined.

Basically, there is presented an authentication type selection for user authentication in a communication system supporting multiple authentication mechanisms. The authentication type selection may comprise a determination of an authentication scheme to be used for authenticating a user equipment based on information in a request from said user equipment, an indication about the authentication scheme to be used, and a determination of a type of an authentication scheme to be used for authenticating said user equipment based on a mapping between private and public user identities and usable authentication types.

Even though the invention is described above with reference to the examples according to the accompanying drawings, it is obvious that the present invention is not restricted thereto. Rather, it is apparent to those skilled in the art that the present invention can be modified in many ways without departing from the scope of the inventive idea as disclosed in the appended claims.

1. A method, comprising:
determining, at a control server apparatus, an authentication scheme to be used for authenticating a user equipment based on information in a request from said user equipment,
indicating, from said control server apparatus to a register apparatus, the authentication scheme to be used, and
determining, at said register apparatus, a type of an authentication scheme to be used for authenticating said user equipment based on a mapping between private and public user identities and usable authentication types.

2. The method according to claim 1, wherein said determining of an authentication scheme comprises at least one of:
detecting whether or not said request specifies integrity protection,
detecting whether or not network-provided access network information exists in said request, and
detecting whether or not said request contains an authorization header.

3. The method according to claim 2, wherein said determining of an authentication scheme does not yield a definite result, when said integrity protection detection yields a negative result, when said access network information detection yields a negative result, and when said authorization header detection yields an affirmative result.

4. The method according to claim 3, wherein said indicating an authentication scheme to be used comprises:
indicating that the authentication scheme to be used is undefined.

5. The method according to claim 4, wherein said indicating an undefined authentication scheme comprises:
transmitting an authentication request from said control server apparatus to said register apparatus, with an authentication scheme being set to be undefined.

6. The method according to claim 2, wherein said determining yields an Early IMS Security, EIS, authentication scheme, when said integrity protection detection yields a negative result, when said access network information detection yields a negative result, and when said authorization header detection yields a negative result.

7. The method according to claim 6, wherein said indicating an authentication scheme to be used comprises:
indicating that the authentication scheme to be used is Early IMS Security, EIS.

8. The method according to claim 1, wherein said determining of a type of authentication scheme comprises:
capturing, as an authentication type parameter, a choice of authentication and key agreement, AKA, authentication using a universal subscriber identity module, USIM, and Early IMS Security, EIS, authentication.

9. The method according to claim 8, wherein said determining of a type of authentication scheme, when said indicated authentication scheme is undefined, further comprises:
comparing a public user identity and a private user identity of said requesting user equipment, wherein
an authentication type is determined out of said choice of said captured authentication type parameter on the basis of a result of said comparison and a pre-stored unique mapping of said private user identity and an authentication type to be used therefor.

10. The method according to claim 9, wherein said private user identity comprises an IP multimedia private identity, IMPI, and said public user identity comprises an IP multimedia public identity, IMPU, and wherein
said authentication type determining yields an Early IMS Security, EIS, authentication, if said identities do not match each other, and
said authentication type determining yields an authentication and key agreement, AKA, authentication using a universal subscriber identity module, USIM, of said user equipment, if said identities match each other.

11. The method according to claim 8, wherein, when said indicated authentication scheme is authentication and key agreement, AKA, authentication, said determining of a authentication type yields authentication and key agreement, AKA, authentication using a universal subscriber identity module, USIM, of said user equipment.

12. The method according to claim 8, wherein, when said indicated authentication scheme is Early IMS Security, EIS, authentication, said determining of a authentication type yields Early IMS Security, EIS, authentication.

13. The method according to claim 1, further comprising:
indicating, from said register apparatus to said control server apparatus, said determined type of authentication scheme to be used for authenticating said user equipment, wherein
said indication is performed by transmitting an authentication response containing authentication parameters for said determined authentication type.

14. The method according to claim 1, further comprising:
authenticating said user equipment by means of said type of authentication scheme being determined.

15. A method for operating a control server apparatus, comprising:
determining an authentication scheme to be used for authenticating a user equipment based on information in a request from said user equipment, and
indicating, to a register apparatus, the authentication scheme to be used.

16. The method according to claim 15, wherein said determining of an authentication scheme comprises at least one of:
detecting whether or not said request specifies integrity protection,
detecting whether or not network-provided access network information exists in said request, and
detecting whether or not said request contains an authorization header.

17. The method according to claim 16, wherein said determining of an authentication scheme does not yield a definite result, when said integrity protection detection yields a negative result, when said access network information detection yields a negative result, and when said authorization header detection yields an affirmative result.

18. The method according to claim 17, wherein said indicating an authentication scheme to be used comprises:
indicating that the authentication scheme to be used is undefined.

19. The method according to claim 18, wherein said indicating an undefined authentication scheme comprises:
transmitting an authentication request to said register apparatus, with an authentication scheme being set to be undefined.

20. The method according to claim 16, wherein said determining yields an Early IMS Security, EIS, authentication scheme, when said integrity protection detection yields a negative result, when said access network information detection yields a negative result, and when said authorization header detection yields a negative result.

21. The method according to claim 20, wherein said indicating an authentication scheme to be used comprises:
indicating that the authentication scheme to be used is Early IMS Security, EIS.

22. A method for operating a register apparatus, comprising:
receiving an indication from a control server apparatus about an authentication scheme to be used for authenticating a user equipment, and
determining a type of an authentication scheme to be used for authenticating said user equipment based on a mapping between private and public user identities and usable authentication types.

23. The method according to claim 22, wherein said determining of a type of authentication scheme comprises:
capturing, as an authentication type parameter, a choice of authentication and key agreement, AKA, authentication using a universal subscriber identity module, USIM, and Early IMS Security, EIS, authentication.

24. The method according to claim 23, wherein said determining of a type of authentication scheme, when said indicated authentication scheme is undefined, further comprises:
comparing a public user identity and a private user identity of said requesting user equipment, wherein
an authentication type is determined out of said choice of said captured authentication type parameter on the basis of a result of said comparison and a pre-stored unique mapping of said private user identity and an authentication type to be used therefor.

25. The method according to claim 24, wherein said private user identity comprises an IP multimedia private identity, IMPI, and said public user identity comprises an IP multimedia public identity, IMPU, and wherein
said authentication type determining yields an Early IMS Security, EIS, authentication, if said identities do not match each other, and
said authentication type determining yields an authentication and key agreement, AKA, authentication using a universal subscriber identity module, USIM, of said user equipment, if said identities match each other.

26. The method according to claim 23, wherein, when said indicated authentication scheme is authentication and key agreement, AKA, authentication, said determining of a authentication type yields authentication and key agreement, AKA, authentication using a universal subscriber identity module, USIM, of said user equipment.

27. The method according to claim 23, wherein, when said indicated authentication scheme is Early IMS Security, EIS, authentication, said determining of a authentication type yields Early IMS Security, EIS, authentication.

28. The method according to claim 22, further comprising:
indicating, to said control server apparatus, said determined type of authentication scheme to be used for authenticating said user equipment, wherein
said indication is performed by transmitting an authentication response containing authentication parameters for said determined authentication type.

29. A control server apparatus, comprising:
a determination unit configured to determine an authentication scheme to be used for authenticating a user equipment based on information in a request received from said user equipment, and
an indication unit configured to indicate, to a register apparatus, the authentication scheme to be used.

30. The control server apparatus according to claim 29, wherein said determination unit comprises at least one of:
a first detection unit configured to detect whether or not said request specifies integrity protection,
a second detection unit configured to detect whether or not network-provided access network information exists in said request, and
a third detection unit configured to detect whether or not said request contains an authorization header.

31. The control server apparatus according to claim 30, wherein said determination unit is configured to yield no definite result, when said first detection unit yields a negative result, when said second detection unit yields a negative result, and when said third detection unit yields an affirmative result.

32. The control server apparatus according to claim 31, wherein said indication unit is configured to indicate that the authentication scheme to be used is undefined.

33. The control server apparatus according to claim 32, wherein said indication unit comprises:
a transmitter configured to transmit an authentication request to said register apparatus, with an authentication scheme being set to be undefined.

34. The control server apparatus according to claim 30, wherein said determination unit is configured to determine an Early IMS Security, EIS, authentication scheme, when said first detection unit yields a negative result, when said second detection unit yields a negative result, and when said third detection unit yields a negative result.

35. The control server apparatus according to claim 34, wherein said indicating unit is configured to indicate that the authentication scheme to be used is Early IMS Security, EIS.

36. The control server apparatus according to claim 29, wherein said control server apparatus comprises a serving control state control function, S-CSCF.

37. A register apparatus, comprising:
a receiver configured to receive an indication from a control server apparatus about an authentication scheme to be used for authenticating a user equipment, and
a determination unit configured to determine a type of an authentication scheme to be used for authenticating said user equipment based on a mapping between private and public user identities and usable authentication types.

38. The register apparatus according to claim 37, wherein said determination unit comprises:
a capturing unit configured to capture, as an authentication type parameter, a choice of authentication and key agreement, AKA, authentication using a universal subscriber identity module, USIM, and Early IMS Security, EIS, authentication.

39. The register apparatus to claim 38, wherein said determination unit comprises:
a comparator configured to compare a public user identity and a private user identity of said requesting user equipment, and
a storage unit configured to store a unique mapping of said private user identity and an authentication type to be used therefor, wherein, when said indicated authentication scheme is undefined,
said determination unit is configured to determine an authentication type out of said choice of said captured authentication type parameter on the basis of a result of said comparator and said mapping.

40. The register apparatus according to claim 39, wherein said private user identity comprises an IP multimedia private identity, IMPI, and said public user identity comprises an IP multimedia public identity, IMPU, and wherein
said determination unit is configured to determine an Early IMS Security, EIS, authentication, if said comparator yields that said identities do not match each other, and
said determination unit is configured to determine an authentication and key agreement, AKA, authentication using a universal subscriber identity module, USIM, of said user equipment, if said comparator yields that said identities match each other.

41. The register apparatus according to claim 37, further comprising:
an indication unit configured to indicate, to said control server apparatus, said determined type of authentication scheme to be used for authenticating said user equipment, wherein
said indication unit further comprises a transmitter configured to transmit an authentication response containing authentication parameters for said determined authentication type.

42. The register apparatus according to claim 37, wherein said register apparatus comprises a home subscriber server, HSS, and/or an IP multimedia register, IMR.

43. A data structure, wherein an authentication scheme information element in a multimedia authentication request, MAR, command is set to be undefined.

44. A computer software or computer program product embodied on a computer-readable medium, which is configured, when being executed on a processor of a control server apparatus, to cause the control server apparatus to
determine an authentication scheme to be used for authenticating a user equipment based on information in a request from said user equipment, and
indicate, to a register apparatus, the authentication scheme to be used.

45. A computer software or computer program product embodied on a computer-readable medium, which is configured, when being executed on a processor of a register apparatus, to cause the register apparatus to
receive an indication from a control server apparatus about an authentication scheme to be used for authenticating a user equipment, and
determine a type of an authentication scheme to be used for authenticating said user equipment based on a mapping between private and public user identities and usable authentication types.
